(19) United States
(12) Patent Application Publication
(10) Pub. No.: US 2015/0377450 A1
(43) Pub. Date: Dec. 31, 2015

(54) DIFFUSION LENS STRUCTURE FOR LIGHT SOURCE, CAPABLE OF CONTROLLING DIFFUSION ANGLE

(71) Applicants: Dong Pil SUH, Seoul (KR); Yukihiro YANAGAWA, Itako, Ibaraki (JP)

(72) Inventors: Dong Pil SUH, Seoul (KR); Yukihiro YANAGAWA, Itako, Ibaraki (JP)

(21) Appl. No.: 14/768,456

(22) PCT Filed: Feb. 17, 2014
(86) PCT No.: PCT/KR2014/001245

§ 371 Date: Aug. 18, 2015

(30) Foreign Application Priority Data
Feb. 18, 2013 (KR) 10-2013-0016727

(51) Int. Cl. F21V 5/00; F21V 14/06

(52) U.S. Cl. CPC F21V 5/004; F21V 14/06; F21Y 2101/02

(57) ABSTRACT

Provided is a diffusion lens structure for a light source, capable of controlling a diffusion angle. The diffusion lens structure for a light source, capable of controlling a diffusion angle, according to one embodiment of the present invention comprises: a substrate for transmitting light; and a plurality of microlenses arranged on one side of the substrate, wherein the plurality of microlenses have different sizes from each other, the plurality of microlenses are similar to each other, one cross section of the plurality of microlenses takes a spherical or elliptical shape and the height of the plurality of microlenses gradually increases or decreases from the center of the substrate toward the periphery.

### TECHNICAL FIELD

The present invention relates to a diffusion lens structure for light source, which allows to adjust diffusion angle, and in particular to a diffusion lens structure for light source, which allows to adjust diffusion angle, wherein light from various light sources, for example, a LED can be diffused, while adjusting diffusion angle.

### BACKGROUND ART

The LED (Light-Emitting Diode) is a semiconductor device. All semiconductors have various capabilities to conduct current with the aid of impurities in an inner structure which produce thanks to a small amount of chemical additive. The N-type impurity allows to add surplus electrons to a semiconductor, and the P-type impurity allows to generate a hole. Electron with negative electricity naturally moves from where there are more electrons (negative) to where there are less electrons.

Inside the diode, an N-type material is present next to a P-type material. In a structure wherein both the N-type material and the P-type material are present between electrodes, current flows in one direction, namely, from the electrode of the N-type to the electrode of the P-type. At the moment electrons drop into the hole, the electrons generate energy in a form of photon. As a result, light emits when electrons move from one side of the diode to the other side thereof. Light with various wavelengths can generate depending on the kinds of materials used in a semiconductor.

Such a light emitting diode can efficiently emit light with low voltage and low current and has longer service life as compared to a common electric bulb. To this end, it is widely used in electron devices and lighting devices which use light.

However, since it generates a high temperature heat, service life may decrease, and there may be changes in luminance of light, and diffusion of light is bad, which causes a lot of limits to use of a precise device. For this reason, it is urgently needed to develop a LED device and a small sized lens which have high efficiency.

### Disclosure of Invention

In a conventional diffusion lens, if a diffusion angle of an emitting light is widened to 160° (±80°), the thickness of the lens physically becomes about 5 mm thick, thus causing limits in application to a thin film device. In a conventional simple pattern, if a diffusion angle is made wider, uniformity of luminance of light at an outer circumference portion may go lower below 50% than the maximum luminance at a central portion, thus causing a problem in an actual application.

Accordingly, the present invention is made considering the above-mentioned problems. As a technical solution for resolving the above mentioned problems, it is an object of the present invention to provide a diffusion lens structure of a thin membrane type which allows to adjust diffusion angle which is formed on a substrate.

The technical solutions of the present invention are not limited by the above-mentioned technical solution. Other technical solutions which are not mentioned in the above may be clearly understood by a person having ordinary skill in the art.

### Technical Solution

To achieve the above objects, according to an exemplary embodiment of the present invention, there is provided a diffusion lens structure for light source, which allows to adjust a diffusion angle, which may include, but is not limited to, a substrate which transmits light; and a plurality of micro lenses which are arranged on one surface of the substrate, wherein the micro lenses are sized different and are shaped similar with each other, and one cross section of each of the micro lenses is formed spherical or elliptical, and the heights of the micro lenses gradually increase or decrease in a direction from a central portion of the substrate to its outer portion.

To achieve the above objects, according to another exemplary embodiment of the present invention, there is provided a diffusion lens structure for light source, which allows to adjust a diffusion angle, which may include, but is not limited to, a substrate which transmits light; and a plurality of micro lenses which are arranged on one surface of the substrate, wherein the micro lenses are sized different and shaped similar with each other, and one cross section of each of the micro lenses is formed triangular, and the heights of the micro lenses gradually increase or decrease in a direction from a central portion of the substrate to its outer portion.

To achieve the above objects, there is provided a diffusion lens structure for light source, which allows to adjust a diffusion angle, which may include, but is not limited to, a substrate which transmits light; and a plurality of micro lenses which are arranged on one surface of the substrate, wherein the micro lenses are sized different, and the sizes of the micro lenses gradually increase or decrease in a direction from a central portion of the substrate to its outer portion.

To achieve the above objects, according to further another exemplary embodiment of the present invention, there is provided a diffusion lens structure for light source, which allows to adjust a diffusion angle, which may include, but is not limited to, a substrate which transmits light; a plurality of first micro lenses which are arranged on one surface of the substrate; and a plurality of second micro lenses which are arranged on the other surface of the substrate, wherein the first and second micro lenses are sized different and shaped similar with each other, and one cross section of each of the first micro lenses is shaped spherical or elliptical, and one cross section of each of the second micro lenses is formed triangular, and the heights of the first and second micro lenses gradually increase or decrease in a direction from a central portion of the substrate to its outer portion, and a part of each of the first micro lenses and a part of each of the second micro lenses are concentrically formed.

### Advantageous Effects

According to the present invention, there is provided a diffusion lens structure which allows to adjust a refraction type of light to a predetermined angle and to generate a uniform light luminance in such a way to form a micro pattern on one surface or both surfaces of a diffusion lens so as to adjust a diffusion angle of light emitting from a light emitting diode, for example, light source.

In addition, since a diffusion lens structure is made in a thin membrane type, a manufacture cost can be lowered. Thanks to wide diffusion of light and uniform luminance, a thin structure of an application instrument, namely, a LED TV can be manufactured, and the necessary number of light emitting diodes can be reduced, and heat from the light emitting diodes can be lowered.

### BRIEF DESCRIPTION OF DRAWINGS

FIG. 1 is a cross sectional view illustrating a diffusion lens structure for light source, which allows to adjust diffusion angle according to an exemplary embodiment of the present invention.

FIG. 2 is a cross sectional view for comparing the substrate in FIG. 1 to the height of a micro lens.

FIG. 3 is a cross sectional view for describing a configuration of a micro lens in FIG. 1.

FIG. 4 is a cross sectional view illustrating a diffusion lens structure for light source, which allows to adjust diffusion angle according to another exemplary embodiment.

FIG. 5 is a cross sectional view for comparing a substrate in FIG. 4 to the height of a micro lens.

FIG. 6 is a cross sectional view for describing a configuration of a micro lens in FIG. 4.

FIG. 7 is a cross sectional view illustrating a diffusion lens structure for light source, which allows to adjust a diffusion angle according to further another exemplary embodiment of the present invention.

FIG. 8 is a graph for showing light diffusion effect based on a diffusion angle of a diffusion lens structure for light source, which allows to adjust diffusion angle of exemplary embodiments of the present invention.

FIGS. 9 to 12 are other graphs showing light diffusion effect based on a diffusion angle of a diffusion lens structure for light source, which allows to adjust diffusion angle of exemplary embodiments of the present invention.

### MODES FOR CARRYING OUT THE INVENTION

Herein after the exemplary embodiments of the present invention will be described with reference to the accompanying drawings. The advantages and features of the present invention and a way for achieving them will be clear with reference to the description which is provided along with the accompanying drawings. The present invention is not limited to the embodiments below, but may be implemented in various aspects. Such embodiments are provided to make perfect the disclosure of the present invention and inform a person having ordinary skill in the art of the scope of the invention. The present invention may be defined by the scope of the claims, and the same reference numbers throughout the specification mean the same components.

Unless otherwise stated, all terms (including technology and science terms) used in the present specification may be used as providing meaning that a person having ordinary skill in the art can understand. The terms defined in dictionary and in general used should not be interpreted ideally or overly unless otherwise stated therein.

The terms used in the present specification are provided to describe embodiments, not intended to limit it. In the present specification, a single form should be interpreted as including plural forms unless otherwise stated herein. The terms “comprises” and/or “comprising” don't exclude any presence or addition of at least one other component except for the mentioned components.

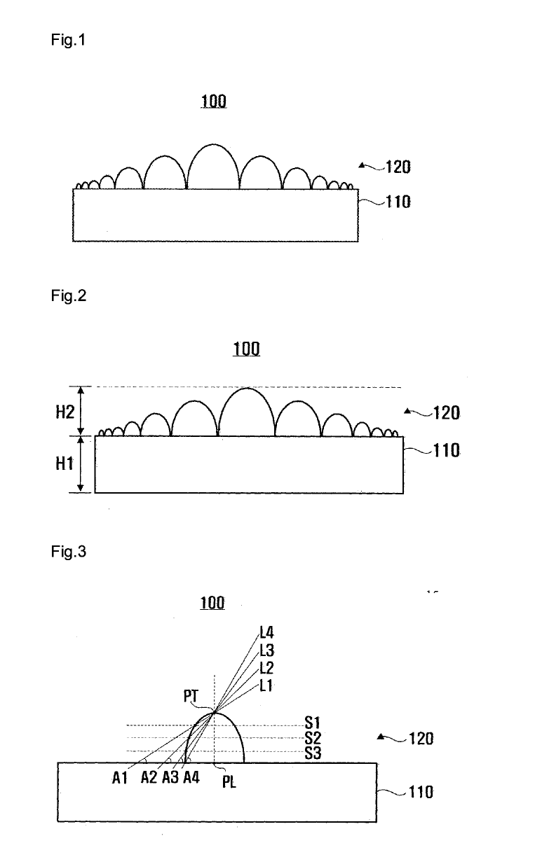

The configuration of a diffusion lens for light source, which allows to adjust a diffusion angle according to an exemplary embodiment of the present invention will be described with reference to the accompanying drawings. FIG. 1 is a cross sectional view illustrating a diffusion lens structure for light source, which allows to adjust diffusion angle according to an exemplary embodiment of the present invention. FIG. 2 is a cross sectional view for comparing the substrate in FIG. 1 to the height of a micro lens. FIG. 3 is a cross sectional view for describing a configuration of a micro lens in FIG. 1.

Referring to FIGS. 1 to 3, the diffusion lens structure 100 for light source, which allows to adjust a diffusion angle according to an exemplary embodiment of the present invention may include, but is not limited to, a substrate 110 which transmits light, and a plurality of micro lenses 120 which are arranged on one surface of the substrate 110, wherein a plurality of the micro lenses 120 are configured similar with each other, and one cross section of each of the micro lenses 120 is formed spherical or elliptical, and the heights of the micro lenses 120 gradually increase or decrease a direction from the center of the substrate 110 to its outer side portion.

The substrate 110 may be made of a transparent material capable of transmitting light, namely, a transparent material, for example, a glass or a transparent plastic film or sheet. In another embodiment, it may be an opaque material which may be appropriate to its application. More specifically, the transparent plastic film may be made of a material containing poly carbonate, poly sulfone, poly acrylate, poly styrene, poly vinyl chloride, poly vinyl alcohol, poly norbornene, and poly ester. More specifically, the substrate 110 may be made of poly ethylene terephtalate or poly ethylene naphthalate. Meanwhile, the substrate 110 may be made using a material, for example, polycarbonate, polyethersulfone or polyarylate which is transparent and flexible for application to a flexible display device.

A plurality of the micro lenses 120 may be arranged on one surface of the substrate 110. A plurality of the micro lenses 120 may be formed integral with the substrate 110, not limited thereto. It may be manufactured separate from the substrate 110 and may be engaged in various ways, for example, an adhering way or a compressing way. The method for manufacturing the micro lenses may be performed by an injection, 2P and thermosetting method if a synthetic resin is used. If glass is used, a redraw and a transferring method may be used.

The pattern sizes and angles of the micro lenses 120 may be adjusted based on the size and shape of light source and the distance between the light emitting diode and the lens and the type of the assembling.

In addition, the micro lenses 120 may be made of the same material as the substrate 110, but it is not limited thereto. The materials may be different from each other, but should be capable of transmitting light. For example, the micro lenses 120 may be made of a material which contains any of PC, PMMA, COC, PET or a transparent resin having more than 89% of transmissivity.

More specifically, it is possible to use an optical resin the transmissivity of which is over 89% and which has good workability or an optical glass with a low level of iron, the transmissivity of which is over 90% and which is glass and has less iron component.

A plurality of the micro lenses 120 allow to diffuse the light which was made incident into the lower surface of the substrate 110 into a wide angle light and have roughly a spherical or elliptical shape, wherein one cross section may have a circular or elliptical shape. The micro lenses 120 may have different sizes in similar shapes.

The heights of the micro lenses 120 may gradually increase or decrease from the center of the substrate 110 to its outer portion, the configuration of which is provided in consideration of the occasion where light source (not illustrated) is arranged in the center of the substrate 110. If the light source is arranged inclined from the center of the substrate 110, the arrangement may change in such a way that the central position of the light source can correspond to the highest portion of each of the micro lenses 120. In addition, if a plurality of light sources are arranged at a lower surface of one substrate 110, there may be present multiple highest portions so that the highest portions of the micro lenses 120 can be defined on the top of where each light source is arranged.

Comparing to the thickness (height: H2) of the substrate 110, the central portion of the micro lenses 120 are maximum 85% (H2=0.85*H1), and the outer portions of the micro lenses 120 may have minimum 12% (H2=0.12*H1).

Referring to FIG. 3, the configuration of one cross section of each of the micro lenses 120 will be specifically described. A first micro lens is arranged in the center of the light source which is arranged at a lower surface of the substrate 110, and the highest point PT and the lowest point PL of the first micro lens pass through one cross section of the first micro lens, and with respect to a virtual central axis vertical with respect to the substrate 110, the interval from the highest point PT to the lowest point PL is divided into four parts, and there may be provided a first horizontal axis S1 parallel to the substrate 110, a second horizontal axis S2 and a third horizontal axis S3.

First to third angles A1, A2 and A3 formed by first to third connection lines L11, L2 and L3 connecting the point where the first to third horizontal axes S1, S2 and S3 meet one cross section of the first micro lens and first to third horizontal axes S1, S2 and S3 may be 10° to 20°, 20° to 30° and 30° to 40°. Namely, the first angle Al formed as the first connection line L1 meets the first horizontal axis S1 may be in a range of 10° to 20°, and the second angle A2 formed as the second connection line L2 meets the second horizontal axis S2 may be in a range of 20° to 30°, and the third angle A3 formed as the third connection line L3 meets the third horizontal axis S3 may be in a range of 30° to 40°.

In addition, the fourth angle formed by the fourth connection line L4 connecting the point where the substrate 110 meets a circumferential portion of the first micro lens on one cross section and the highest point PT, and the substrate 110 may be in a range of 40° to 50°.

If the first angle Al is smaller than 10° or is larger than 20°, the shape of the first micro lens may be deformed, thus light diffusion effect may greatly reduce, whereupon light does not diffuse about the light source (refer to FIGS. 8 to 12).

In the same way, if the second angle A2 is smaller than 20° or is larger than 30°, and if the third angle A3 is smaller than 30° or is larger than 40°, and if the fourth angle A4 is smaller than 40° or is larger than 50°, the whole shape of the first micro lens may be deformed, so the light diffusion effect may be greatly reduced, whereupon light does not diffuse about the center of the light source (refer to FIGS. 8 to 12).

Namely, the angle ranges of the first angle Al to the fourth angle A4 determine the whole shape of the micro lenses, so the light diffusion effect may greatly change based on the shape of the micro lens.

The shapes and arrangements of the micro lenses 120 play a role of diffusing at a wider angle the light made incident on a lower surface of the substrate 110, and since the efficiency of diffusing light changes based on the type of the lens, the specified shape of the micro lens is necessary.

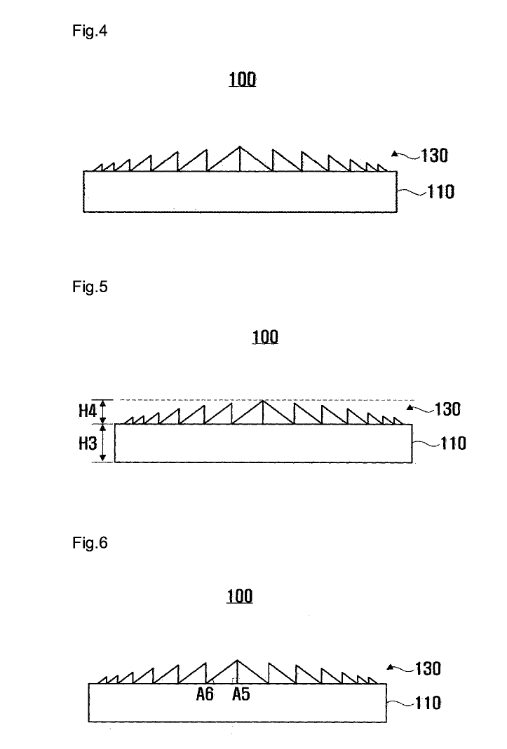

Referring to FIGS. 4 to 6, the configuration of the diffusion lens structure for light source, which allows to adjust diffusion angle according to another exemplary embodiment of the present invention will be described. FIG. 4 is a cross sectional view illustrating a diffusion lens structure for light source, which allows to adjust diffusion angle according to another exemplary embodiment. FIG. 5 is a cross sectional view for comparing a substrate in FIG. 4 to the height of a micro lens. FIG. 6 is a cross sectional view for describing a configuration of a micro lens in FIG. 4.

Referring to FIGS. 4 to 6, the diffusion lens structure 100 for light source, which allows to adjust a diffusion angle according to another exemplary embodiment of the present invention may include, but is not limited to, a substrate 110 which transmits light, and a plurality of micro lenses 130 which are arranged on one surface of the substrate 110. A plurality of the micro lenses 130 are sized different and are shaped similar with each other, and one cross section of each of the micro lenses 130 is triangular, and the heights of the micro lenses 130 gradually increase or decrease in a direction from the center of the substrate 110 to its outer portion.

One cross section of each of the micro lenses 130 may be a right-angled triangle, wherein the angle A6 between a side of one cross section and the substrate 110 may be in a range of 1° to 50°.

The shape and angle of each of the micro lenses 130 may be a deformed form of Fresnel lens and may play a role of guiding the light inside the lens by uniformly refracting incident light off the surface of the lens or diffusing the light incident onto the lower surface of the substrate 110.

A first side of one cross section of one micro lens of the multiple micro lenses 130 is arranged vertical with respect to the substrate 110 and may form a right angle A5.

The heights of the micro lenses 130 may be 0.17 to 0.83 with respect to the thickness of the substrate. Namely, comparing to the thickness (height: H3) of the substrate 110, the central portions of the micro lenses 130 may be maximum 83% (H4=0.83*H3), and the outer portions of the micro lenses 130 may be minimum 17% (H4=0.17*H3).

Like in the previous exemplary embodiment, the micro lenses 130 may be made of a material containing PC, PMMA, COC, PET or a transparent resin having over 89% of transmissivity.

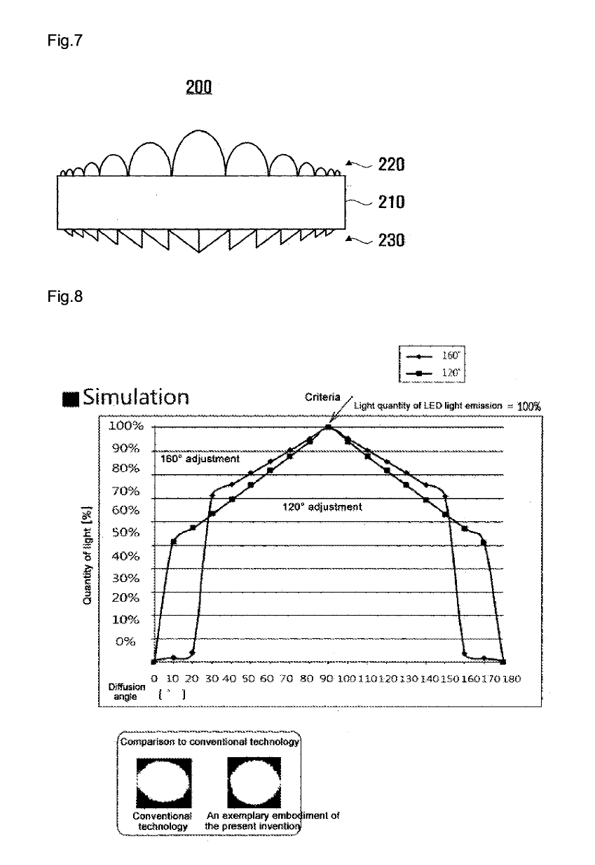

The diffusion lens structure for light source, which allows to adjust diffusion angle according to another exemplary embodiment of the present invention will be described with reference to FIG. 7. FIG. 7 is a cross sectional view illustrating a diffusion lens structure for light source, which allows to adjust a diffusion angle according to further another exemplary embodiment of the present invention.

The diffusion lens structure 200 for light source, which allows to adjust diffusion angle according to another exemplary embodiment of the present invention may include, but is not limited thereto, a substrate 210 which transmits light, a plurality of first micro lenses 220 which are arranged on one surface of the substrate 210, and a plurality of second micro lenses 230 which are arranged on the other surface of the substrate 210. The first and second micro lenses 220 and 230 are sized different, and one cross section of each of the first micro lenses 220 is formed spherical or elliptical, and one cross section of each of the second micro lenses 230 is formed triangular, and the heights of the first and second micro lenses 220 and 230 gradually increase or decrease in a direction from the central portion of the substrate 210 to its outer portion. A part of each of the first micro lenses 220 and a part of each of the first micro lenses 230 are concentrically formed.

Like in the previous embodiment, the heights of the first micro lenses 220 may be 0.12 to 0.85 as compared to the thickness of the substrate 210, and the heights of the second micro lenses 230 may be 0.17 to 0.83 as compared to the thickness of the substrate 210.

The light source is arranged at the side of the first micro lens 220, and the light transmits through the first micro lens 220, the substrate 210, and the second micro lens 230. On the contrary, the light source may be disposed at the side of the second micro lens 230.

The first micro lens 22 and the second micro lens 230 are shaped different, and the shapes of the first micro lenses 220 may be same, and the sizes thereof are different, and they may have a predetermined similarity. The second micro lenses 230 may be shaped same and sized different and may have a predetermined similarity.

In some other exemplary embodiments, the diffusion lens structure for light source, which allows to adjust diffusion angle may include, but is not limited to, a substrate which transmits light, and a plurality of micro lenses which are arranged on one surface of the substrate. The micro lenses may be sized different, and the sizes of the micro lenses may gradually increase or decrease in a direction from the center of the substrate to its outer portion.

The shapes of the micro lenses may not be limited, and only the sizes of the micro lenses may increase or decrease in a predetermined direction when arranging it.

FIG. 8 is a graph for showing light diffusion effect based on a diffusion angle of a diffusion lens structure for light source, which allows to adjust diffusion angle of exemplary embodiments of the present invention.

Referring to FIG. 8, there is disclosed a luminance distribution of light when the diffusion angle is adjusted to 120° and 160°. If the diffusion angle is 120°, the luminance in a corresponding section is relatively high and diffusion is uniform, whereas the diffusion range (30° to 150°) is narrow. If the diffusion angle is 160°, the luminance in a corresponding section is distributed wide, whereas the diffusion range (10° to 170°) is wide, and a relative luminance difference is larger at left and right sides with respect to a 90° section (highest point) which becomes a criteria.

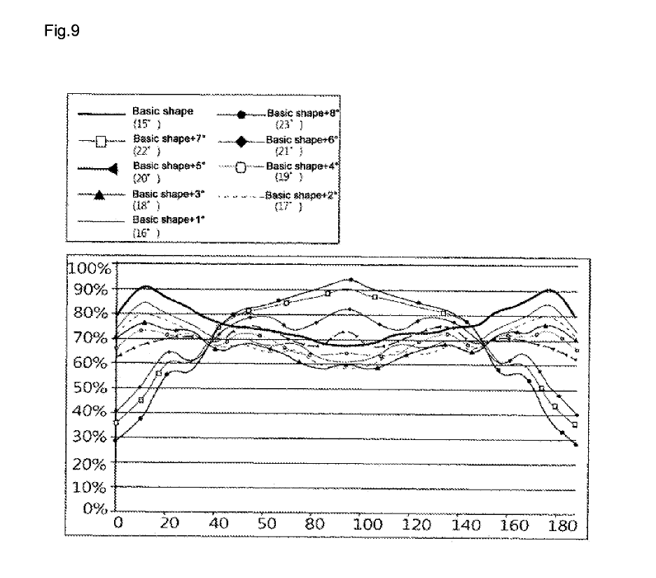

Referring to FIGS. 9 to 12, there are illustrated other graphs which show light diffusion effects based on the diffusion angle of a diffusion lens structure for light source, which allows to adjust diffusion angle according to an exemplary embodiment of the present invention.

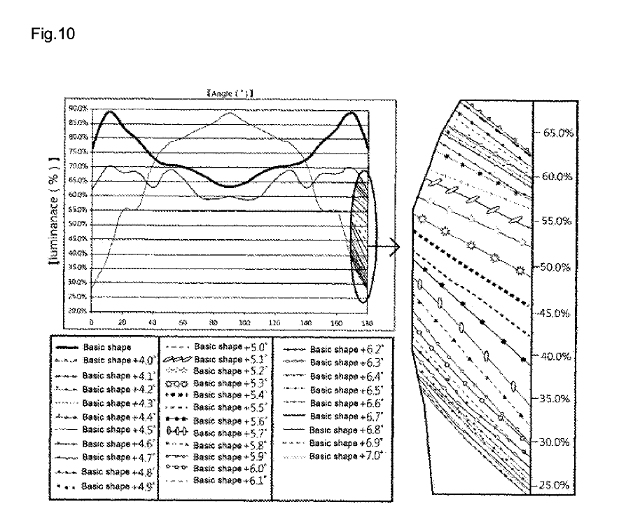

Referring to FIGS. 9 and 10, if the angle of Al in FIG. 3 is over 20°, it is possible to confirm that the luminance distribution changes greatly in all the ranges. If it is over 20°, as illustrated in FIG. 9, it is possible to confirm that the luminance data sharply changes. As illustrated in FIG. 10, it is possible to confirm that the data changes greatly at the point of 20° in the data between 19° and 22°. Namely, a great change takes place between the graphs between 20° and 21°, so the data changes greatly, which has effect on the whole luminance distribution. As compared to different angle interval, since there is a big difference in the intervals of 20° and 21°, it is possible to confirm that a critical meaning based on the change in significant data.

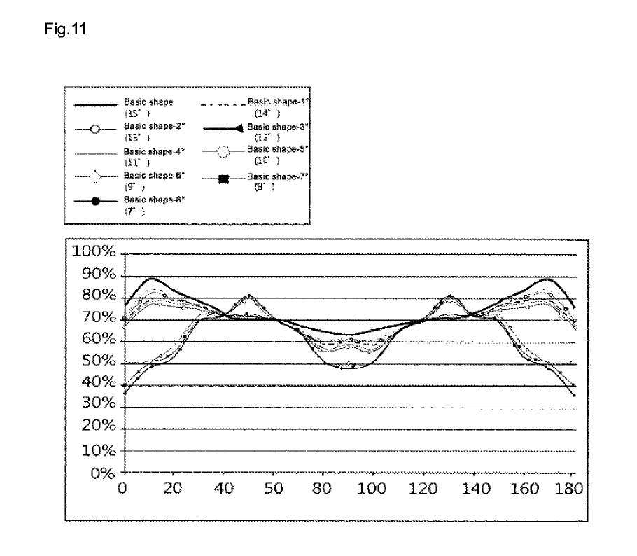

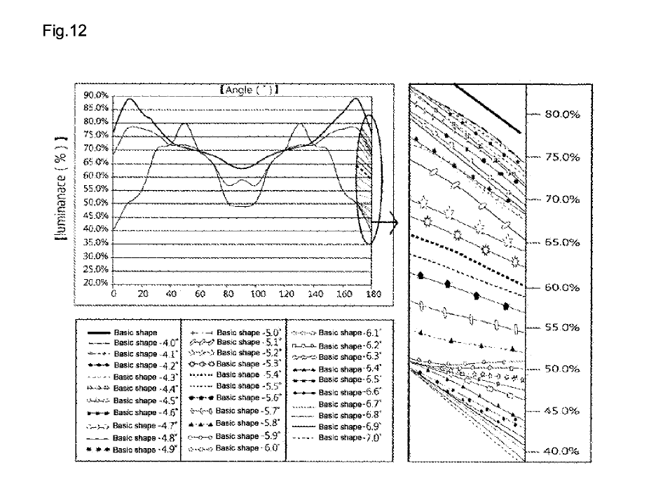

Referring to FIGS. 11 and 12, as illustrated therein, if the angle of A1 in FIG. 3 is smaller than 10°, it is possible to confirm that the luminance distribution in the whole ranges changes greatly. Referring to FIG. 11, if the angle is smaller than 10°, it is possible to confirm that the luminance data sharply changes, and referring to FIG. 12, it is possible to confirm that the data greatly changes at the point of 10° in the data between 8° and 11°. The above mentioned experiment result proves that a desired uniform luminance distribution can be obtained when the angle range of A1 is in a range of 10° to 20°, which means that 10° to 20° which is an angle range of A1 has a critical meaning.

Namely, if the range is over a range of 10° to 20°, the luminance difference at the center portion (near 90°) and both corner portions (near 0° and) 180°) sharply increases, whereupon it is impossible to obtain a diffusion lens structure which has a desired uniform luminance distribution.

In this way, if the shape the micro lens and the angle range are adjusted, it is possible to let a diffusion lens structure have various diffusion angles.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A diffusion lens structure for light source, which allows to adjust a diffusion angle, comprising:
a substrate which transmits light; and
a plurality of micro lenses which are arranged on one surface of the substrate, wherein the micro lenses are sized different and are shaped similar with each other, and one cross section of each of the micro lenses is formed spherical or elliptical, and the heights of the micro lenses gradually increase or decrease in a direction from a central portion of the substrate to its outer portion.

2. The structure of claim 1, wherein the heights of the micro lenses are 0.12 to 0.85 as compared to the thickness of the substrate.

3. The structure of claim 1, wherein a first micro lens is arranged at a central portion of the substrate, and there are provided a first horizontal axis, a second horizontal axis and a third horizontal axis which divide a portion from the highest point to the lowest point into four parts with respect to a virtual central axis vertical with respect to the substrate, while passing through the highest pint and the lowest point of the first micro lens in one cross section of the first micro lens, and first to third angles sequentially formed by the first to third connection lines connecting the point where the first to third horizontal axes meet the one cross section and the highest point and the first to third horizontal axes are 10° to 20°, 20° to 30° and 30° to 40°.

4. The structure of claim 3, wherein a fourth angle formed by a fourth connection line connecting the point where the substrate and the circumference of the first micro lens meet each other on the one cross section and the highest point and the substrate are 40° and 50°.

5. The structure of claim 1, wherein a plurality of the micro lenses are made of a material containing PC, PMMA, COC, PET or a transparent resin having over 89% of transmissivity.

6. A diffusion lens structure for light source, which allows to adjust a diffusion angle, comprising:
a substrate which transmits light; and
a plurality of micro lenses which are arranged on one surface of the substrate, wherein the micro lenses are sized different and shaped similar with each other, and one cross section of each of the micro lenses is formed triangular, and the heights of the micro lenses gradually increase or decrease in a direction from a central portion of the substrate to its outer portion.

7. The structure of claim 6, wherein the one cross section of each of the micro lenses is a right-angled triangle.

8. The structure of claim 7, wherein an angle between a side of the one cross section and the substrate is in a range of 1° to 50°.

9. The structure of claim 6, wherein a first side of the one cross section is arranged vertical with respect to the substrate.

10. The structure of claim 6, wherein the heights of the micro lenses are 0.17 to 0.83 as compared to the thickness of the substrate.

11. The structure of claim 6, wherein the micro lenses are made of a material containing PC, PMMA, COC, PET or a transparent resin having over 89% of transmissivity.

12. A diffusion lens structure for light source, which allows to adjust a diffusion angle, comprising:
a substrate which transmits light; and
a plurality of micro lenses which are arranged on one surface of the substrate, wherein the micro lenses are sized different, and the sizes of the micro lenses gradually increase or decrease in a direction from a central portion of the substrate to its outer portion.

13. A diffusion lens structure for light source, which allows to adjust a diffusion angle, comprising:
a substrate which transmits light;
a plurality of first micro lenses which are arranged on one surface of the substrate; and
a plurality of second micro lenses which are arranged on the other surface of the substrate, wherein the first and second micro lenses are sized different and shaped similar with each other, and one cross section of each of the first micro lenses is shaped spherical or elliptical, and one cross section of each of the second micro lenses is formed triangular, and the heights of the first and second micro lenses gradually increase or decrease in a direction from a central portion of the substrate to its outer portion, and a part of each of the first micro lenses and a part of each of the second micro lenses are concentrically formed.

14. The structure of claim 13, wherein the heights of the first micro lenses are 0.12 to 0.85 as compared to the thickness of the substrate.

15. The structure of claim 13, wherein the heights of the second micro lenses are 0.17 to 0.83 as compared to the thickness of the substrate.
